(19) United States
(12) Patent Application Publication
(10) Pub. No.: US 2022/0302640 A1
(43) Pub. Date: Sep. 22, 2022

(54) High Voltage Connector for Use in an Electric Vehicle

(71) Applicant: Celanese International Corporation, Irving, TX (US)

(72) Inventors: Guglielmo Pasetti, Lodi (LO) (IT); Holger Brandt, Schwanau (DE)

(21) Appl. No.: 17/691,195

(22) Filed: Mar. 10, 2022

Related U.S. Application Data
(60) Provisional application No. 63/233,512, filed on Aug. 16, 2021.
(60) Provisional application No. 63/162,054, filed on Mar. 17, 2021.

(51) Int. Cl. H01R 13/53; H01R 13/533; H01R 13/52; H01R 13/502; H01R 43/26; C08K 5/00; C08K 5/5313

(52) U.S. Cl. CPC H01R 13/53; H01R 13/533; H01R 13/5216; H01R 13/5025; H01R 43/26; C08K 5/0066; C08K 5/5313; H01R 2201/26

(57) ABSTRACT

A high voltage connector for an electrical vehicle is provided. The connector comprises a connector portion that includes an electrical pin and a protection member extending from a base and surrounding at least a portion of the electrical pin. The base, protection member, or a combination thereof contain a polyamide composition that includes from about 20 wt. % to about 70 wt. % of at least one polyamide, from about 10 wt. % to about 60 wt. % of inorganic fibers, and from about 10 wt. % to about 35 wt. % of a flame retardant system that includes at least one halogen-free organophosphorous compound. The polyamide composition exhibits a CTI of about 600 volts or more and a V0 rating at a thickness of 0.8 mm as determined in accordance with UL94.

### CROSS REFERENCE TO RELATED APPLICATIONS

The present application claims filing benefit of U.S. Provisional Patent Applications Ser. Nos. 63/162,054 having a filing date of Mar. 17, 2021 and 63/233,512 having a filing date of Aug. 16, 2021, which are incorporated herein by reference in their entirety.

### BACKGROUND OF THE INVENTION

Electric vehicles, such as battery-electric vehicles, plug-in hybrid-electric vehicles, mild hybrid-electric vehicles, or full hybrid-electric vehicles generally have an electric powertrain that contains an electric propulsion source (e.g., battery) and a transmission. The propulsion source provides a high voltage electrical current that is supplied to the transmission via one or more power electronics modules. Due to their small size and complex geometry, attempts have been made at forming high voltage electrical connectors from polyamide compositions. Unfortunately, however, many conventional polyamide compositions, particularly those reinforced with glass fibers, lack sufficient insulative properties (e.g., comparative tracking index (“CTI”)) and ignition resistance. As such, a need currently exists for a high voltage connector for use in electric vehicles that can exhibit a high CTI, but also remain flame retardant and possess good mechanical properties.

### SUMMARY OF THE INVENTION

In accordance with one embodiment of the present invention, a high voltage connector for an electrical vehicle is disclosed. The connector comprises a connector portion that includes an electrical pin and a protection member extending from a base and surrounding at least a portion of the electrical pin. The base, protection member, or a combination thereof contain a polyamide composition that includes from about 20 wt. % to about 70 wt. % of at least one polyamide, from about 10 wt. % to about 60 wt. % of inorganic fibers, and from about 10 wt. % to about 35 wt. % of a flame retardant system that includes at least one halogen-free organophosphorous compound. The polyamide composition exhibits a comparative tracking index of about 600 volts or more as determined in accordance with IEC 60112:2003 at a thickness of 3 millimeters and a V0 rating at a thickness of 0.8 mm as determined in accordance with UL94.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a schematic illustration of one embodiment of an electric vehicle that may employ the high voltage connector of the present invention;

FIG. 2 is a perspective view of one embodiment of the high voltage connector of the present invention;

FIG. 3 is a plan view of the high voltage connector of FIG. 2 in which the first and second connector portions are disengaged; and

FIG. 4 is a plan view of the high voltage connector of FIG. 2 in which the first and second connector portions are engaged.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a high voltage connector for use in an electric vehicle, such as a battery-powered electric vehicle, fuel cell-powered electric vehicle, plug-in hybrid-electric vehicle (PHEV), mild hybrid-electric vehicle (MHEV), full hybrid-electric vehicle (FHEV), etc. Notably, at least one component of the connector is formed from a polyamide composition that contains at least one polyamide resin in combination with inorganic fibers and a flame retardant system that includes a halogen-free organophoshporous compound. Through selective control over the nature of these and relative concentration of these components, the present inventors have discovered that the resulting polyamide composition can achieve a unique combination of insulative properties, flame retardancy, and good mechanical properties even at relatively small thickness values, such as about 4 millimeters or less, in some embodiments about from about 0.2 to about 3.2 millimeters, in some embodiments from about 0.4 to about 2.5 millimeters, and in some embodiments, from about 0.8 to about 2 millimeters.

The insulative properties of the polyamide composition may be characterized by a high comparative tracking index (“CTI”), such as about 550 volts or more, in some embodiments about 580 volts or more, and in some embodiments, about 600 volts or more, as determined in accordance with IEC 60112:2003 at a part thickness such as noted above (e.g., 3 millimeters). The polyamide composition may also be relatively resistance to the release of acids in a moist environment, which can minimize corrosion. More particularly, 72 hours after formation of an aqueous dispersion containing 70 wt. % of a deionized water phase and 30 wt. % of the polyamide composition, the pH value of the deionized water phase has a pH value that is relatively close to neutral, such as from about 4 to about 8, in some embodiments from about 4 to about 7.5, and in some embodiments, from about 5 to about 7.

The flammability of the composition of the present invention can be characterized in accordance the procedure of Underwriter's Laboratory Bulletin 94 entitled “Tests for Flammability of Plastic Materials, UL94.” Several ratings can be applied based on the time to extinguish ((total flame time of a set of 5 specimens) and ability to resist dripping as described in more detail below. According to this procedure, for example, the composition may exhibit a V0 rating at a part thickness such as noted above (e.g., from about 0.4 to about 3.2 millimeters, and particularly from about 0.8 to about 2 millimeters, e.g., 0.8 millimeters), which means that it has a total flame time of about 50 seconds or less. To achieve a V0 rating, the composition may also exhibit a total number of drips of burning particles that ignite cotton of 0. The flame retardancy of the polyamide composition may likewise be characterized by glow wire testing. For example, during glow wire testing, the temperature at which the composition will ignite and burn for longer than 5 seconds when placed into contact with a heated test plate can be measured. This temperature is known as the Glow Wire Ignition Temperature (“GWIT”) and is determined in accordance with IEC-60695-2-13:2010 at a part thickness such as noted above. For example, at thicknesses of from about 0.8 to about 2 millimeters (e.g., 0.8 millimeters), the polyamide composition of the present invention may exhibit a GWIT of about 650° C. or more, in some embodiments about 700° C. or more, in some embodiments from about 750° C. to about 900° C., and in some embodiments, from about 800° C. to about 875° C. The flame retardancy of the composition can also be characterized by the highest temperature at which the material does not ignite or self-extinguish within 30 seconds after removal of the heated element during a glow wire test conducted in accordance with IEC-60695-2-12:2010 at a part thickness such as noted above. This temperature is known as the Glow Wire Flammability Index (“GWFI”). For example, at thicknesses of from about 0.8 to about 2 millimeters (e.g., 0.8 millimeters), the GWFI is typically about 900° C. or more, in some embodiments from about 920° C. to about 1050° C., and in some embodiments, from about 950° C. to about 1000° C. for the polyamide composition of the present invention.

Conventionally, it was believed that compositions having flame retardant properties could not achieve the desired mechanical properties for use in an electric vehicle. The present inventors have discovered, however, that the composition of the present invention can still achieve good impact strength, tensile properties, and flexural properties. For example, the polyamide composition may exhibit a Charpy unnotched impact strength of about 5 kJ/m² or more, in some embodiments about 6 kJ/m² or more, in some embodiments from about 7 to about 30 kJ/m², and in some embodiments, from about 8 to about 25 kJ/m², measured at 23° C. or −30° C. according to ISO Test No. 179-1:2010 (technically equivalent to ASTM D256-10, Method B). The composition may also exhibit a tensile strength of about 40 Megapascals (“MPa”) or more, in some embodiments about 50 MPa or more, in some embodiments from about 55 to about 200 MPa, and in some embodiments, from about 60 to about 150 MPa, as well as a tensile modulus of about 7,000 MPa or more, in some embodiments about 8,000 MPa or more, in some embodiments about 9,000 MPa or more, in some embodiments from about 11,000 to about 50,000 MPa, and in some embodiments, from about 12,000 to about 25,000 MPa, wherein the tensile properties are determined in accordance with ISO Test No. 527:2012 (technically equivalent to ASTM D638-14 at 23° C. The composition may also exhibit a flexural strength of from about 70 to about 500 MPa, in some embodiments from about 80 to about 400 MPa, and in some embodiments, from about 90 to about 300 MPa and/or a flexural modulus of from about 10,000 MPa to about 30,000 MPa, in some embodiments from about 12,000 MPa to about 25,000 MPa, and in some embodiments, from about 14,000 MPa to about 20,000 MPa. The flexural properties may be determined in accordance with ISO Test No. 178:2010 (technically equivalent to ASTM D790-10) at 23° C.

The high voltage connector may have a variety of different configurations depending on the particular application in which it is employed. Typically, however, the connector contains a first connector portion that contains at least one electrical pin and a protection member extending from a base that surrounds at least a portion of the electrical pin. The base and/or the protection member may contain the polyamide composition of the present invention. For instance, in certain embodiments, the protection member may have a relatively small wall thickness, such as about 4 millimeters or less, in some embodiments from about 0.2 to about 3.2 millimeters, in some embodiments from about 0.4 to about 2.5 millimeters, and in some embodiments, from about 0.8 to about 2 millimeters. As noted above, the present inventors have discovered that the polyamide composition may exhibit good performance even at such low thickness values. The first connector portion may be configured to mate with an opposing second connector portion that contains a receptacle for receiving the electrical pin. In such embodiments, the second connector portion may contain at least one receptable configured to receive the electrical pin of the first connector portion and a protection member extending from a base that surrounds at least a portion of receptacle. The base and/or the protection member of the second connector portion may also contain the polyamide composition of the present invention. For instance, in certain embodiments, the thickness of the protection member of the second connector portion may be within the ranges noted above and thus beneficially formed from the polyamide composition.

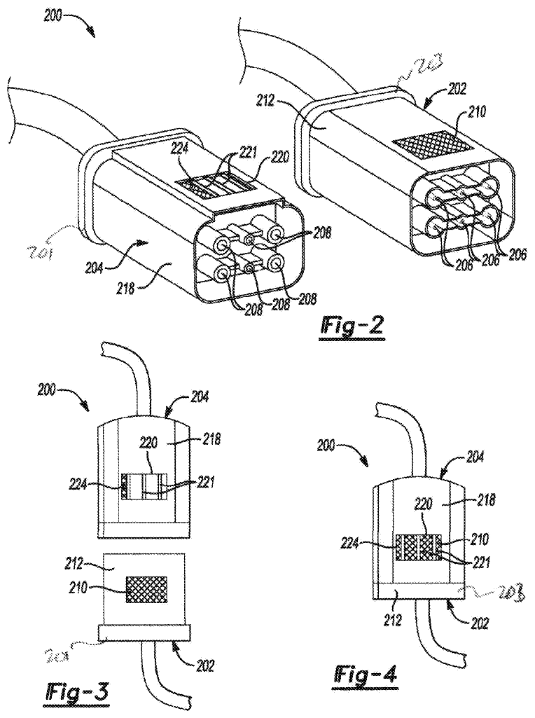

Referring to FIGS. 2-4, one particular embodiment of a high voltage connector 200 is shown for use in an electric vehicle. The connector 200 contains a first connector portion 202 and a second connector portion 204. The first connector portion 202 may include one or more electrical pins 206 and the second connector portion 204 may include one or more receptacles 208 for receiving the electrical pins 206. A first protection member 212 may extend from a base 203 of the first connecting portion 202 to surround the pins 206, and similarly, a second protection member 218 may extend from a base 201 of the second connecting portion 204 to surround the receptacles 208. In certain cases, the periphery of the first protective member 212 may extend beyond an end of the electrical pins 203 and the periphery of the second protective member 218 may extend beyond an end of the receptacles 208. As noted above, the base 203 and/or the first protection member 212 of the first connector portion 202, as well as the base 201 and/or the second protection member 218 of the second connector portion 204, may be formed from the polyamide composition of the present invention. Such parts may be formed from the polyamide composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polyamide composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polyamide composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

Although by no means required, the first connector portion 202 may also include an identification mark 210 secured to or defined by the first protective member 212. The second connecting portion 204 may also optionally define an alignment window 220 sized according to the identification mark 210 to more easily determine when the portions are fully mated. For instance, the identification mark 210 may not be readable unless blockers 221 cover a portion of the identification mark 210. Optionally, the second connecting portion 204 may include a supplemental mark 224 located adjacent to the alignment window 220.

Various embodiments of the present invention will now be described in more detail.

### I. Polyamide Composition

A. Polyamide

Typically, polyamides constitute from about 20 wt. % to about 70 wt. %, in some embodiments from about 30 wt. % to about 60 wt. %, and in some embodiments, from about 35 wt. % to about 55 wt. % of the composition. Polyamides generally have a CO—NH linkage in the main chain and are obtained by condensation of a diamine and a dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Of course, aromatic and/or alicyclic diamines may also be employed. Furthermore, examples of the dicarboxylic acid component may include aromatic dicarboxylic acids (e.g., terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc.), aliphatic dicarboxylic acids (e.g., adipic acid, sebacic acid, etc.), and so forth. Examples of lactams include pyrrolidone, aminocaproic acid, caprolactam, undecanlactam, lauryl lactam, and so forth. Likewise, examples of amino carboxylic acids include amino fatty acids, which are compounds of the aforementioned lactams that have been ring opened by water.

In certain embodiments, an “aliphatic” polyamide is employed that is formed only from aliphatic monomer units (e.g., diamine and dicarboxylic acid monomer units). Particular examples of such aliphatic polyamides include, for instance, nylon-4 (poly-α-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable. In one particular embodiment, for example, nylon-6 or nylon-66 may be used alone. In other embodiments, blends of nylon-6 and nylon-66 may be employed. When such a blend is employed, the weight ratio of nylon-66 to nylon-6 is typically from 1 to about 2, in some embodiments from about 1.1 to about 1.8, and in some embodiments, from about 1.2 to about 1.6.

Of course, it is also possible to include aromatic monomer units in the polyamide such that it is considered semi-aromatic (contains both aliphatic and aromatic monomer units) or wholly aromatic (contains only aromatic monomer units). For instance, suitable semi-aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/i 1-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephlhalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene lerephthalamide/dodecamelhylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

The polyamide employed in the polyamide composition is typically crystalline or semi-crystalline in nature and thus has a measurable melting temperature. The melting temperature may be relatively high such that the composition can provide a substantial degree of heat resistance to a resulting part. For example, the polyamide may have a melting temperature of about 220° C. or more, in some embodiments from about 240° C. to about 325° C., and in some embodiments, from about 250° C. to about 335° C. The polyamide may also have a relatively high glass transition temperature, such as about 30° C. or more, in some embodiments about 40° C. or more, and in some embodiments, from about 45° C. to about 140° C. The glass transition and melting temperatures may be determined as is well known in the art using differential scanning calorimetry (“DSC”), such as determined by ISO Test No. 11357-2:2013 (glass transition) and 11357-3:2011 (melting).

B. Inorganic Fibers

Inorganic fibers typically constitute from about 10 wt. % to about 60 wt. %, in some embodiments from about 15 wt. % to about 55 wt. %, and in some embodiments, from about 20 wt. % to about 50 wt. % of the composition. The inorganic fibers generally have a high degree of tensile strength relative to their mass. For example, the ultimate tensile strength of the fibers is typically from about 1,000 to about 15,000 MPa, in some embodiments from about 2,000 MPa to about 10,000 MPa, and in some embodiments, from about 3,000 MPa to about 6,000 MPa. The high strength fibers may be formed from materials that are also electrically insulative in nature, such as glass, ceramics (e.g., alumina or silica), etc., as well as mixtures thereof. Glass fibers are particularly suitable, such as E-glass, A-glass, C-glass, D-glass, AR-glass, R-glass, S1-glass, S2-glass, etc., and mixtures thereof. The inorganic fibers may have a relatively small median diameter, such as about 50 micrometers or less, in some embodiments from about 0.1 to about 40 micrometers, and in some embodiments, from about 2 to about 20 micrometers, such as determined using laser diffraction techniques in accordance with ISO 13320:2009 (e.g., with a Horiba LA-960 particle size distribution analyzer). It is believed that the small diameter of such fibers can allow their length to be more readily reduced during melt blending, which can further improve surface appearance and mechanical properties. After formation of the polymer composition, for example, the average length of the inorganic fibers may be relatively small, such as from about 10 to about 800 micrometers, in some embodiments from about 100 to about 700 micrometers, and in some embodiments, from about 200 to about 600 micrometers. The inorganic fibers may also have a relatively high aspect ratio (average length divided by nominal diameter), such as from about 1 to about 100, in some embodiments from about 10 to about 60, and in some embodiments, from about 30 to about 50.

C. Flame Retardant System

In addition to the components above, the polyamide composition also contains a flame retardant system that is capable of achieving the desired flammability performance, insulative properties, and mechanical properties without the need for conventional halogen-based flame retardants. The flame retardant system typically constitutes from about 10 wt. % to about 35 wt. %, in some embodiments from about 12 wt. % to about 30 wt. %, and in some embodiments, from about 15 wt. % to about 25 wt. % of the polyamide composition. The flame retardant system generally includes at least one halogen-free flame retardant. The halogen (e.g., bromine, chlorine, and/or fluorine) content of such a flame retardant is typically about 1,500 parts per million by weight (“ppm”) or less, in some embodiments about 900 ppm or less, and in some embodiments, about 50 ppm or less. In certain embodiments, the flame retardants are complete free of halogens (i.e., 0 ppm). The specific nature of the halogen-free flame retardants is selected to help achieve the desired flammability properties without adversely impacting the mechanical properties of the composition.

In this regard, the flame retardant system includes one or more halogen-free organophosphorous flame retardants, typically in an amount from about 20 wt. % to 100 wt. %, in some embodiments from about 30 wt. % to 100 wt. %, and in some embodiments, from about 40 wt. % to about 80 wt. % of the flame retardant system. One particularly suitable organophosphorous flame retardant is a phosphinate, which can enhance the flame retardancy of the overall composition, particularly for relatively thin parts, without adversely impacting mechanical and insulative properties. Such phosphinates are typically salts of a phosphinic acid and/or diphosphinic acid, such as those having the general formula (I) and/or formula (II):

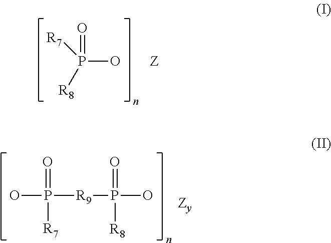

wherein,

R₇ and R₈ are, independently, hydrogen or substituted or unsubstituted, straight chain, branched, or cyclic hydrocarbon groups (e.g., alkyl, alkenyl, alkylnyl, aralkyl, aryl, alkaryl, etc.) having 1 to 6 carbon atoms, particularly alkyl groups having 1 to 4 carbon atoms, such as methyl, ethyl, n-propyl, iso-propyl, n-butyl, or tert-butyl groups;

R₉ is a substituted or unsubstituted, straight chain, branched, or cyclic C₁-C₁₀ alkylene, arylene, arylalkylene, or alkylarylene group, such as a methylene, ethylene, n-propylene, iso-propylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, t-butylnaphthylene, phenylethylene, phenylpropylene or phenylbutylene group;

Z is Mg, Ca, Al, Sb, Sn, Ge, Ti, Zn, Fe, Zr, Ce, Bi, Sr, Mn, Li, Na, K, and/or a protonated nitrogen base;

y is from 1 to 4, and preferably 1 to 2 (e.g., 1);

n is from 1 to 4, and preferably 1 to 2 (e.g. 1); and

m is from 1 to 4 and preferably 1 to 2 (e.g., 2).

The phosphinates may be prepared using any known technique, such as by reacting a phosphinic acid with a metal carbonate, metal hydroxide, or metal oxides in aqueous solution. Particularly suitable phosphinates include, for example, metal salts of dimethylphosphinic acid, ethylmethylphosphinic acid, diethylphosphinic acid, methyl-n-propylphosphinic acid, methane-di(methylphosphinic acid), ethane-1,2-di(methylphosphinic acid), hexane-1,6-di(methylphosphinic acid), benzene-1,4-di(methylphosphinic acid), methylphenylphosphinic acid, diphenylphosphinic acid, hypophosphoric acid, etc. The resulting salts are typically monomeric compounds; however, polymeric phosphinates may also be formed. Particularly suitable metals for the salts may include Al and Zn. For instance, one particularly suitable phosphinate is zinc diethylphosphinate, such as commercially available from Clariant under the name EXOLIT® OP 950. Another particularly suitable phosphinate is aluminum diethylphosphinate, such as commercially available from Clariant under the name EXOLIT® OP 1230.

Of course, other suitable organophosphorous flame retardants may also be employed in the polyamide composition. Examples of such flame retardants may include, for instance, salts of phosphorous acid, such as phosphates, phosphonites, phosphites, phosphonates, etc.; phosphazenes; and so forth, as well as combination thereof. The cation used to form the salts of phosphorous acid may be a metal, such as Mg, Ca, Al, Sb, Sn, Ge, Ti, Zn, Fe, Zr, Ce, Bi, Sr, Mn, Li, Na, or K, and/or a protonated nitrogen base. When employing a metal cation, aluminum and zinc are particularly suitable, such as aluminum phosphite, zinc phosphite, aluminum phosphonate, zinc phoshonate, etc. Suitable protonated nitrogen bases may likewise include those having a substituted or unsubstituted ring structure, along with at least one nitrogen heteroatom in the ring structure (e.g., heterocyclic or heteroaryl group) and/or at least one nitrogen-containing functional group (e.g., amino, acylamino, etc.) substituted at a carbon atom and/or a heteroatom of the ring structure. Examples of such heterocyclic groups may include, for instance, pyrrolidine, imidazoline, pyrazolidine, oxazolidine, isoxazolidine, thiazolidine, isothiazolidine, piperidine, piperazine, thiomorpholine, etc. Likewise, examples of heteroaryl groups may include, for instance, pyrrole, imidazole, pyrazole, oxazole, isoxazole, thiazole, isothiazole, triazole, furazan, oxadiazole, tetrazole, pyridine, diazine, oxazine, triazine, tetrazine, and so forth. If desired, the ring structure of the base may also be substituted with one or more functional groups, such as acyl, acyloxy, acylamino, alkoxy, alkenyl, alkyl, amino, aryl, aryloxy, carboxyl, carboxyl ester, cycloalkyl, hydroxyl, halo, haloalkyl, heteroaryl, heterocyclyl, etc. Substitution may occur at a heteroatom and/or a carbon atom of the ring structure.

One suitable nitrogen base is melamine, which contains a 1,3,5 triazine ring structure substituted with an amino functional group at each of the three carbon atoms. Examples of suitable melamine phosphate salts may include, for instance, melamine orthophosphate, melamine pyrophosphate, melamine polyphosphate, etc. Melamine polyphosphate may, for instance, be those commercially available from BASF under the name MELAPUR® (e.g., MELAPUR® 200 or 200/70). Another suitable nitrogen base is piperazine, which is a six-membered ring structure containing two nitrogen atoms at opposite positions in the ring. Examples of suitable piperazine phosphate salts may include, for instance, piperazine orthophosphate, piperazine pyrophosphate, piperazine polyphosphate, etc. In certain embodiments, a blend of melamine and piperazine phosphate salts may be employed in the flame retardant system.

Of course, other organophosphorous flame retardants may also be employed in the flame retardant system. For example, in one embodiment, mono- and oligomeric phosphoric and phosphonic esters may be employed, such as tributyl phosphate, triphenyl phosphate, tricresyl phosphate, diphenyl cresyl phosphate, diphenyl octyl phosphate, diphenyl 2-ethylcresyl phosphate, tri(isopropylphenyl) phosphate, resorcinol-bridged oligophosphate, bisphenol A phosphates (e.g., bisphenol A-bridged oligophosphate or bisphenol A bis(diphenyl phosphate)), etc., as well as mixtures thereof. Aryl phosphates, aryl phosphonites, aryl phosphonates, hypophosphorous acid salts, red phosphorous, etc., may also be employed as suitable organophorphorous flame retardants.

In certain embodiments, the flame retardant system may be formed entirely from one type of organophophorous flame retardant, such as a phosphinate. In other cases, however, it may be desirable to employ combinations of two or more types of organophosphorous flame retardants to achieve the desired properties. For example, in one embodiment, phosphinates may constitute from about 50 wt. % to about 95 wt. %, in some embodiments from about 60 wt. % to about 92 wt. %, and in some embodiments, from about 70 wt. % to about 90 wt. % of the flame retardant system, and also from about 5 wt. % to about 25 wt. %, in some embodiments from about 9 wt. % to about 22 wt. %, in some embodiments from about 10 wt. % to about 20 wt. %, and in some embodiments, from about 11 wt. % to about 18 wt. % of the entire polyamide composition. Likewise, other types of organophosphorous flame retardants, such as salts of phosphorous acid (e.g., aluminum phosphite, aluminum phosphonate, melamine polyphosphate, etc.), may constitute from about 5 wt. % to about 50 wt. %, in some embodiments from about 8 wt. % to about 40 wt. %, and in some embodiments, from about 10 wt. % to about 30 wt. % of the flame retardant system.

The flame retardant system may also be formed entirely of organophosphorous flame retardants, such as those described above. In certain embodiments, however, it may be desired to employ additional compounds to help increase the effectiveness of the system. For example, inorganic compounds may be employed as low halogen char-forming agents and/or smoke suppressants in combination with organophosphorous compound(s). Suitable inorganic compounds (anhydrous or hydrates) may include, for instance, inorganic molybdates, such as zinc molybdate (e.g., commercially available under the designation Kemgard® from Huber Engineered Materials), calcium molybdate, ammonium octamolybdate, zinc molybdate-magnesium silicate, etc. Other suitable inorganic compounds may include inorganic borates, such as zinc borate (commercially available under the designation Firebrake® from Rio Tento Minerals), etc.); zinc phosphate, zinc hydrogen phosphate, zinc pyrophosphate, basic zinc chromate (VI) (zinc yellow), zinc chromite, zinc permanganate, silica, magnesium silicate, calcium silicate, calcium carbonate, titanium dioxide, magnesium dihydroxide, and so forth. In particular embodiments, it may be desired to use an inorganic zinc compound, such as zinc molybdate, zinc borate, etc., to enhance the overall performance of the composition. When employed, such inorganic compounds (e.g., zinc borate) may, for example, constitute from about 1 wt. % to about 20 wt. %, in some embodiments from about 2 wt. % to about 15 wt. %, and in some embodiments, from about 3 wt. % to about 10 wt. % of the flame retardant system, and also from about 0.1 wt. % to about 10 wt. %, in some embodiments from about 0.2 wt. % to about 5 wt. %, and in some embodiments, from about 0.5 wt. % to about 4 wt. % of the entire polyamide composition.

If desired, other additives may also be employed in the flame retardant system of the present invention. For instance, nitrogen-containing synergists may be employed that act in conjunction with the organophosphorous compound and/or other components to result in a more effective flame retardant system. Such nitrogen-containing synergists may include those of the formulae (Ill) to (VIII), or a mixture of thereof:

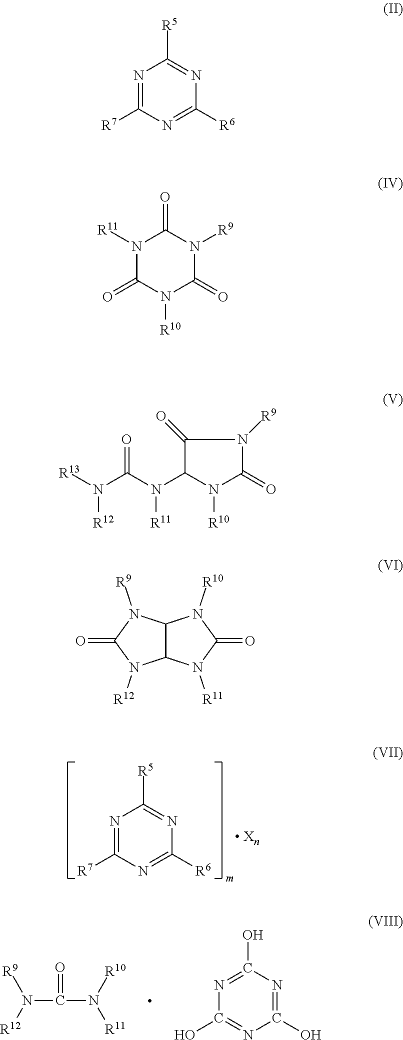

wherein,

R₅, R₆, R₇, R₉, R₁₀, R₁₁, R₁₂, and R₁₃ are, independently, hydrogen; C₁-C₈ alkyl; C₅-C₁₆-cycloalkyl or alkylcycloalkyl, optionally substituted with a hydroxy or a C₁-C₄ hydroxyalkyl; C₂-C₈ alkenyl; C₁-C₈ alkoxy, acyl, or acyloxy; C₆-C₁₂-aryl or arylalkyl; OR⁸ or N(R⁸)R⁹, wherein R⁸ is hydrogen, C₁-C₈ alkyl, C₅-C₁₆ cycloalkyl or alkylcycloalkyl, optionally substituted with a hydroxy or a C₁-C₄ hydroxyalkyl, C₂-C₈ alkenyl, C₁-C₈ alkoxy, acyl, or acyloxy, or C₆-C₁₂ aryl or arylalkyl;

m is from 1 to 4;

n is from 1 to 4;

X is an acid that can form adducts with triazine compounds of the formula III. For example, the nitrogen-containing synergist may include benzoguanamine, tris(hydroxyethyl) isocyanurate, allantoin, glycoluril, melamine, melamine cyanurate, dicyandiamide, guanidine, etc. Examples of such synergists are described in U.S. Pat. No. 6,365,071 to Jenewein, et al.; U.S. Pat. No. 7,255,814 to Hoerold, et al.; and 7,259,200 to Bauer, et al. One particularly suitable synergist is melamine cyanurate, such as commercially available from BASF under the name MELAPUR® MC (e.g., MELAPUR® MC 15, MC25, MC50).

When employed, nitrogen-containing synergists may, for example, constitute about from about 0.5 wt. % to about 30 wt. %, in some embodiments from about 1 wt. % to about 25 wt. %, and in some embodiments, from about 2 wt. % to about 20 wt. % of the flame retardant system, and also from about 0.1 wt. % to about 10 wt. %, in some embodiments from about 0.5 wt. % to about 8 wt. %, and in some embodiments, from about 1 wt. % to about 6 wt. % of the entire polyamide composition.

The flame retardant system and/or the polyamide composition itself generally has a relatively low content of halogens (i.e., bromine, fluorine, and/or chlorine), such as about 15,000 parts per million (“ppm”) or less, in some embodiments about 5,000 ppm or less, in some embodiments about 1,000 ppm or less, in some embodiments about 800 ppm or less, and in some embodiments, from about 1 ppm to about 600 ppm. Nevertheless, in certain embodiments of the present invention, halogen-based flame retardants may still be employed as an optional component. Particularly suitable halogen-based flame retardants are fluoropolymers, such as polytetrafluoroethylene (PTFE), fluorinated ethylene polypropylene (FEP) copolymers, perfluoroalkoxy (PFA) resins, polychlorotrifluoroethylene (PCTFE) copolymers, ethylene-chlorotrifluoroethylene (ECTFE) copolymers, ethylene-tetrafluoroethylene (ETFE) copolymers, polyvinylidene fluoride (PVDF), polyvinylfluoride (PVF), and copolymers and blends and other combination thereof. When employed, such halogen-based flame retardants typically constitute only about 10 wt. % or less, in some embodiments about 5 wt. % or less, and in some embodiments, about 1 wt. % or less of the flame retardant system. Likewise, the halogen-based flame retardants typically constitute about 5 wt. % or less, in some embodiments about 1 wt. % or less, and in some embodiments, about 0.5 wt. % or less of the entire polyamide composition.

D. Other Components

A wide variety of additional additives can also be included in the polyamide composition, such as impact modifiers, compatibilizers, particulate fillers (e.g., mineral fillers), lubricants, pigments, antioxidants, light stabilizers, heat stabilizers, slip additives, and/or other materials added to enhance properties and processability. In certain embodiments, for example, the composition may contain a UV stabilizer. Suitable UV stabilizers may include, for instance, benzophenones, benzotriazoles (e.g., 2-(2-hydroxy-3,5-di-α-cumylphenyl)-2H-benzotriazole (TINUVIN® 234), 2-(2-hydroxy-5-tert-octylphenyl)-2H-benzotriazole (TINUVIN® 329), 2-(2-hydroxy-3-α-cumyl-5-tert-octylphenyl)-2H-benzotriazole (TINUVIN® 928), etc.), triazines (e.g., 2,4-diphenyl-6-(2-hydroxy-4-hexyloxyphenyl)-s-triazine (TINUVIN® 1577)), sterically hindered amines (e.g., bis(2,2,6,6-tetramethyl-4-piperidyl)sebacate (TINUVIN® 770) or a polymer of dimethyl succinate and 1-(2-hydroxyethyl)-4-hydroxy-2,2,6,6-tetramethyl-4-piperidine (TINUVIN® 622)), and so forth, as well as mixtures thereof. When employed, such UV stabilizers typically constitute from about 0.05 wt. % to about 2 wt. % in some embodiments from about 0.1 wt. % to about 1.5 wt. %, and in some embodiments, from about 0.2 wt. % to about 1.0 wt. % of the composition.

### II. Formation

The polyamide, inorganic fibers, flame retardant system, and other optional additives may be melt processed or blended together. The components may be supplied separately or in combination to an extruder that includes at least one screw rotatably mounted and received within a barrel (e.g., cylindrical barrel) and may define a feed section and a melting section located downstream from the feed section along the length of the screw. The fibers may optionally be added a location downstream from the point at which the polyamide is supplied (e.g., hopper). If desired, the flame retardant(s) may also be added to the extruder a location downstream from the point at which the polyamide is supplied. One or more of the sections of the extruder are typically heated, such as within a temperature range of from about 200° C. to about 450° C., in some embodiments, from about 220° C. to about 350° C., and in some embodiments, from about 250° C. to about 350° C. to form the composition. The speed of the screw may be selected to achieve the desired residence time, shear rate, melt processing temperature, etc. For example, the screw speed may range from about 50 to about 800 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

Regardless of the particular manner in which it is formed, the resulting polyamide composition can possess excellent thermal properties. For example, the melt viscosity of the polyamide composition may be low enough so that it can readily flow into the cavity of a mold having small dimensions. In one particular embodiment, the polyamide composition may have a melt viscosity of from about 400 to about 1,000 Pascal-seconds (“Pa-s”), in some embodiments from about 450 to about 900 Pa-s, and in some embodiments, from about 500 to about 800 Pa-s, determined at a shear rate of 1000 seconds⁻¹. Melt viscosity may be determined in accordance with ISO Test No. 11443:2005 at a temperature that is 15° C. higher than the melting temperature of the composition (e.g., 285° C.).

### III. Electric Vehicle

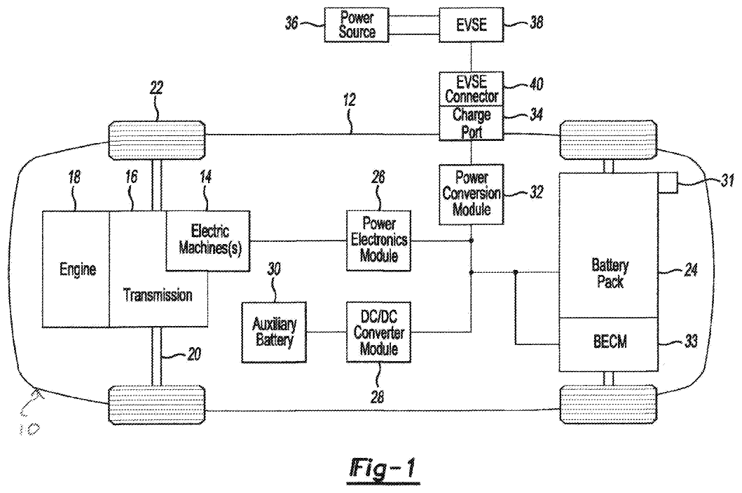

As noted above, the high voltage electrical connector is configured for use in an electric vehicle. For example, the connector may be employed in the powertrain to accomplish a variety of different purposes. For instance, the high voltage connector may electrically connect a propulsion source (e.g., battery, fuel cell, etc.) to a power electronics module and/or the power electronics module to certain electric machines and/or the transmission. Referring to FIG. 1, for instance, one embodiment of an electric vehicle 12 that includes a powertrain 10 is shown. The powertrain 10 contains one or more electric machines 14 connected to a transmission 16, which in turn is mechanically connected to a drive shaft 20 and wheels 22. Although by no means required, the transmission 16 in this particular embodiment is also connected to an engine 18. The electric machines 14 may be capable of operating as a motor or a generator to provide propulsion and deceleration capability. The powertrain 10 also includes a propulsion source, such as a battery pack 24, which stores and provides energy for use by the electric machines 14. The battery pack 24 typically provides a high voltage current output (e.g., DC current) from one or more battery cell arrays that may include one or more battery cells.

The powertrain 10 may also contain at least one power electronics module 26 that is connected to the battery pack 24 and that may contain a power converter (e.g., inverter, rectifier, voltage converter, etc., as well as combinations thereof). The power electronics module 26 is typically electrically connected to the electric machines 14 and provides the ability to bi-directionally transfer electrical energy between the battery pack 24 and the electric machines 14. For example, the battery pack 24 may provide a DC voltage while the electric machines 14 may require a three-phase AC voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the battery pack 24. The description herein is equally applicable to a pure electric vehicle. The battery pack 24 may also provide energy for other vehicle electrical systems. For example, the powertrain may employ a DC/DC converter module 28 that converts the high voltage DC output from the battery pack 24 to a low voltage DC supply that is compatible with other vehicle loads, such as compressors and electric heaters. In a typical vehicle, the low-voltage systems are electrically connected to an auxiliary battery 30 (e.g., 12V battery). A battery energy control module (BECM) 33 may also be present that is in communication with the battery pack 24 that acts as a controller for the battery pack 24 and may include an electronic monitoring system that manages temperature and charge state of each of the battery cells. The battery pack 24 may also have a temperature sensor 31, such as a thermistor or other temperature gauge. The temperature sensor 31 may be in communication with the BECM 33 to provide temperature data regarding the battery pack 24. The temperature sensor 31 may also be located on or near the battery cells within the traction battery 24. It is also contemplated that more than one temperature sensor 31 may be used to monitor temperature of the battery cells.

In certain embodiments, the battery pack 24 may be recharged by an external power source 36, such as an electrical outlet. The external power source 36 may be electrically connected to electric vehicle supply equipment (EVSE) that regulates and manages the transfer of electrical energy between the power source 36 and the vehicle 12. The EVSE 38 may have a charge connector 40 for plugging into a charge port 34 of the vehicle 12. The charge port 34 may be any type of port configured to transfer power from the EVSE 38 to the vehicle 12 and may be electrically connected to a charger or on-board power conversion module 32. The power conversion module 32 may condition the power supplied from the EVSE 38 to provide the proper voltage and current levels to the battery pack 24. The power conversion module 32 may interface with the EVSE 38 to coordinate the delivery of power to the vehicle 12.

As is known to those skilled in the art, the high voltage connector of the present invention may be employed in the powertrain of an electric vehicle to accomplish a variety of different purposes. Referring again to FIG. 1, for instance, the high voltage connector (not shown) may electrically connect the battery pack 24 to a power electronics module, such as the power electronics module 26, the DC/DC converter module 28, and/or the power conversion module 32. The high voltage connector (not shown) may also electrically connect a power electronics module (e.g., module 32) to certain electric machines 14 and/or the power electronics module and/or electric machines 14 to the transmission 16. Of course, apart from being used in the powertrain, the high voltage connector may also be employed in conjunction with other parts of the electric vehicle. In one embodiment, for instance, the high voltage connector may be employed in the electric vehicle supply equipment, such as the charge connector 40 shown in FIG. 1.

The present invention may be better understood with reference to the following examples.

### Test Methods

Tensile Modulus, Tensile Stress, and Tensile Elongation at Break: Tensile properties may be tested according to ISO Test No. 527:2012 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus and Flexural Stress: Flexural properties may be tested according to ISO Test No. 178:2010 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Unotched Charpy Impact Strength: Unotched Charpy properties may be tested according to ISO Test No. ISO 179-1:2010) (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be 23° C.

Notched Charpy Impact Strength: Notched Charpy properties may be tested according to ISO Test No. ISO 179-1:2010) (technically equivalent to ASTM D256-10, Method B). This test may be run using a Type A notch (0.25 mm base radius) and Type 1 specimen size (length of 80 mm, width of 10 mm, and thickness of 4 mm). Specimens may be cut from the center of a multi-purpose bar using a single tooth milling machine. The testing temperature may be 23° C. or −30° C.

Comparative Tracking Index (“CTI”): The comparative tracking index (CTI) may be determined in accordance with International Standard IEC 60112-2003 to provide a quantitative indication of the ability of a composition to perform as an electrical insulating material under wet and/or contaminated conditions. In determining the CTI rating of a composition, two electrodes are placed on a molded test specimen. A voltage differential is then established between the electrodes while a 0.1% aqueous ammonium chloride solution is dropped onto a test specimen. The maximum voltage at which five (5) specimens withstand the test period for 50 drops without failure is determined. The test voltages range from 100 to 600 V in 25 V increments. The numerical value of the voltage that causes failure with the application of fifty (50) drops of the electrolyte is the “comparative tracking index.” The value provides an indication of the relative track resistance of the material. According to UL746A, a nominal part thickness of 3 mm is considered representative of performance at other thicknesses.

pH Test: A test is conducted to measure the pH of the water phase of an aqueous dispersion after contact with a sample. First, the pH of deionized water is determined to serve as a reference. Then, an aqueous dispersion is formed by placing 3 grams of pellet samples into 7 grams of deionized water within a sealed container (70 wt. % deionized water phase, 30 wt. % of pellets as a dispersed phase). The container is stored in an oven for 72 hours at a temperature under 70° C. Thereafter, the pH of the water phase is determined.

UL94: A specimen is supported in a vertical position and a flame is applied to the bottom of the specimen. The flame is applied for ten (10) seconds and then removed until flaming stops, at which time the flame is reapplied for another ten (10) seconds and then removed. Two (2) sets of five (5) specimens are tested. The sample size is a length of 125 mm, width of 13 mm, and thickness of 0.8 mm. The two sets are conditioned before and after aging. For unaged testing, each thickness is tested after conditioning for 48 hours at 23° C. and 50% relative humidity. For aged testing, five (5) samples of each thickness are tested after conditioning for 7 days at 70° C.

| Vertical | |
|---|---|
| Ratings | Requirements |
| V-0 | Specimens must not burn with flaming combustion for more |
| | than 10 seconds after either test flame application. |
| | Total flaming combustion time must not exceed 50 seconds |
| | for each set of 5 specimens. |
| | Specimens must not burn with flaming or glowing combustion |
| | up to the specimen holding clamp. |
| | Specimens must not drip flaming particles that ignite the cotton. |
| | No specimen can have glowing combustion remain for longer |
| | than 30 seconds after removal of the test flame. |
| V-1 | Specimens must not burn with flaming combustion for more |
| | than 30 seconds after either test flame application. |
| | Total flaming combustion time must not exceed 250 seconds |
| | for each set of 5 specimens. |
| | Specimens must not burn with flaming or glowing combustion |
| | up to the specimen holding clamp. |
| | Specimens must not drip flaming particles that ignite the cotton. |
| | No specimen can have glowing combustion remain for longer |
| | than 60 seconds after removal of the test flame. |
| V-2 | Specimens must not burn with flaming combustion for more |
| | than 30 seconds after either test flame application. |
| | Total flaming combustion time must not exceed 250 seconds |
| | for each set of 5 specimens. |
| | Specimens must not burn with flaming or glowing combustion |
| | up to the specimen holding clamp. |
| | Specimens can drip flaming particles that ignite the cotton. |
| | No specimen can have glowing combustion remain for longer |
| | than 60 seconds after removal of the test flame. |

### Examples 1-4

Four (4) different polyamide resin samples are formed from the components listed in the table below for use in forming a high voltage connector of an electrical vehicle.

| | Ex. 1 | Ex. 2 | Ex. 3 | Ex. 4 |
|---|---|---|---|---|
| | (wt. %) | (wt. %) | (wt. %) | (wt. %) |
| Nylon 6,6 | — | 24.90 | 29.90 | 31.65 |
| Nylon 6 | 44.90 | 20.00 | 20.00 | 18.00 |
| Glass Fibers | 30.00 | 30.00 | 25.00 | 30.00 |
| DEPAL ®¹ | 19.00 | 19.00 | 19.00 | 19.00 |
| Color Masterbatch | 4.15 | 4.15 | 4.15 | — |
| Lubricants | 1.40 | 1.40 | 1.40 | 0.50 |
| Antioxidants | 0.40 | 0.40 | 0.40 | 0.20 |
| UV Stabilizers | 0.10 | 0.10 | 0.10 | 0.10 |
| Heat Stabilizers | — | — | — | 0.50 |
| Slip Additives | 0.05 | 0.05 | 0.05 | 0.05 |

¹DEPAL ® contains approximately 80 wt. % of aluminum phosphinate and 20 wt. % of a halogen-free synergistic flame retardant.

Once formed, the resulting compositions were then injected molded at a temperature of about 280° C. and a tool temperature of from 80° C. to 90° C. The injection molded samples of Examples 3 were tested for various properties as described above. The results are set forth below.

| | Ex. 3 |
|---|---|
| UL94 0.4 mm | V0 |
| UL94 0.8 mm | V0 |
| CTI (3.0 mm) | 600 V |

### Examples 5-12

Eight (8) different polyamide resin samples are formed from the components listed in the table below for use in forming a high voltage connector of an electrical vehicle. The samples are formed using a co-rotating twin-screw extruder (ZSK40 by Coperion) having a standard screw design. The extruder is equipped with a “weight loss” multi-feeder system, with the option to add the components from the main hopper and downstream. The temperatures of the barrel and the die head are between 270 to 290° C., the melt temperature is below 300° C., and the throughput range is 80 to 120 kilograms per hour. The components of each formulation are set forth in more detail below.

| | Ex. 5 | Ex. 6 | Ex. 7 | Ex. 8 | Ex. 9 | Ex. 10 | Ex. 11 |
|---|---|---|---|---|---|---|---|
| | (wt. %) | (wt. %) | (wt. %) | (wt. %) | (wt. %) | (wt. %) | (wt. %) |
| Nylon 6,6 | 36 | 31 | — | 43 | 35 | — | 36.7 |
| Nylon 6 | 20 | 20 | 51 | 10 | 10 | 45 | 10 |
| Glass Fibers | 25 | 30 | 30 | 25 | 30 | 30 | 25 |
| Dehydrated Zinc Borate | | — | — | 1 | 1 | 1 | 2 |
| Melamine Polyphosphate | — | — | — | 11.3 | 11.5 | 11.5 | 11.5 |
| Zinc Phosphinate | — | — | — | 8.7 | 11.5 | 11.5 | 11.5 |
| Aluminum Phosphinate | 18 | 18 | 18 | — | — | — | — |
| Stabilizers/LubricantsAntioxidants | 1 | 1 | 1 | 1 | 1 | 1 | 3.3 |

Once formed, the resulting compositions were then injected molded at a temperature of about 280° C. and a tool temperature of from 80° C. to 90° C. The injection molded samples of Examples 5-11 were tested for various properties as described above. The results are set forth below.

| | Ex. 5 | Ex. 6 | Ex. 7 | Ex. 8 | Ex. 9 | Ex. 10 | Ex. 11 |
|---|---|---|---|---|---|---|---|
| UL94 0.4 mm | V0/V2 | V0/V2 | V0/V2 | V0/V2 | V0 | V0 | V0 |
| UL94 0.8 mm | V0 | V0 | V0 | V2 | V0 | V0 | V0 |
| UL94 1.6 mm | V0 | V0 | V0 | V0 | V0 | V0 | V0 |
| CTI (3.0 mm) | 600 | 600 | 600 | — | 600 | 600 | 600 |
| Tensile Yield Strength (MPa) | 130.5 | 145.1 | 140.0 | 139.1 | 143.2 | 144.0 | 140 |
| Elongation at Break (%) | 3.5 | 2.9 | 3.0 | 3.0 | 2.9 | 2.7 | 2.9 |
| Tensile Modulus (MPa) | 9,000 | 10,400 | 10,000 | 8,800 | 10,800 | 10,400 | 9,200 |
| Charpy Notched at 23° C. (kJ/m²) | 9.0 | 10.5 | 11.5 | 7.8 | 10.1 | 13.7 | 8.5 |
| Charpy Notched at −30° C. (kJ/m²) | 7.5 | 9.5 | — | 6.6 | 9.3 | 11.0 | 7.5 |
| Corrosion at 300° C. (mg) | 5.1 | 7.6 | 5.5 | 4.3 | 5.4 | 3.0 | — |
| pH Test | 4.3 | 4.3 | 4.4 | — | — | — | 5.5 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A high voltage connector for an electrical vehicle, the connector comprising a connector portion that includes an electrical pin and a protection member extending from a base and surrounding at least a portion of the electrical pin, wherein the base, protection member, or a combination thereof contain a polyamide composition that includes from about 20 wt. % to about 70 wt. % of at least one polyamide, from about 10 wt. % to about 60 wt. % of inorganic fibers, and from about 10 wt. % to about 35 wt. % of a flame retardant system that includes at least one halogen-free organophosphorous compound, further wherein the polyamide composition exhibits a comparative tracking index of about 600 volts or more as determined in accordance with IEC 60112:2003 at a thickness of 3 millimeters and a V0 rating at a thickness of 0.8 mm as determined in accordance with UL94.

2. The high voltage connector of claim 1, wherein the polyamide composition exhibits a tensile modulus of about 8,500 MPa or more as determined in accordance with ISO Test No. 527-1:2019.

3. The high voltage connector of claim 1, wherein the protection member has a wall thickness of from about 0.8 to about 2 millimeters.

4. The high voltage connector of claim 1, wherein a periphery of the protective member extends beyond an end of the electrical pin.

5. The high voltage connector of claim 1, wherein the protection member contains the polyamide composition.

6. The high voltage connector of claim 1, wherein the connector further comprises a second connector portion that includes a receptacle for receiving the electrical pin and a protection member extending from a base and surrounding at least a portion of the receptacle.

7. The high voltage connector of claim 6, wherein the base of the second connecting portion, the protection member of the second connecting portion, or a combination thereof contains the polyamide composition.

8. The high voltage connector of claim 1, wherein the polyamide includes an aliphatic polyamide.

9. The high voltage connector of claim 9, wherein the polyamide composition includes a combination of nylon-6 and nylon-6,6.

10. The high voltage connector of claim 1, wherein the inorganic fibers include glass fibers.

11. The high voltage connector of claim 1, wherein the flame retardant system includes a phosphinate having the general formula (I) and/or formula (II): 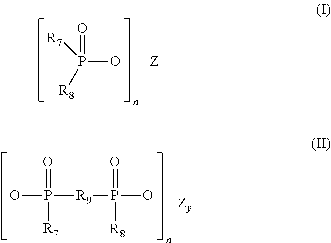
wherein,
R₇ and R₈ are, independently, hydrogen or substituted or unsubstituted, straight chain, branched, or cyclic hydrocarbon groups having 1 to 6 carbon atoms;
R₉ is a substituted or unsubstituted, straight chain, branched, or cyclic C₁-C₁₀ alkylene, arylene, arylalkylene, or alkylarylene group;
Z is Mg, Ca, Al, Sb, Sn, Ge, Ti, Zn, Fe, Zr, Ce, Bi, Sr, Mn, Li, Na, K, and/or a protonated nitrogen base;
y is from 1 to 4;
n is from 1 to 4; and
m is from 1 to 4.

12. The high voltage connector of claim 1, wherein the phosphinate is a metal salt of dimethylphosphinic acid, ethylmethylphosphinic acid, diethylphosphinic acid, methyl-n-propylphosphinic acid, methane-di(methylphosphinic acid), ethane-1,2-di(methylphosphinic acid), hexane-1,6-di(methylphosphinic acid), benzene-1,4-di(methylphosphinic acid), methylphenylphosphinic acid, diphenylphosphinic acid, hypophosphoric acid, or a mixture thereof.

13. The high voltage connector of claim 12, wherein the phosphinate is zinc diethylphosphinate, aluminum diethylphosphinate, or a combination thereof.

14. The high voltage connector of claim 12, wherein the flame retardant system further includes a salt of a phosphorous acid.

15. The high voltage connector of claim 14, wherein the flame retardant system includes a metal phosphite, metal phosphonate, or a combination thereof.

16. The high voltage connector of claim 14, wherein the flame retardant system includes melamine pyrophosphate, melamine polyphosphate, piperazine orthophosphate, piperazine pyrophosphate, piperazine polyphosphate, or a combination thereof.

17. The high voltage connector of claim 1, wherein the flame retardant system further includes an inorganic compound.

18. The high voltage connector of claim 17, wherein the inorganic compound includes zinc borate.

19. The high voltage connector of claim 1, wherein the halogen content of the flame retardant system is about 1,000 parts per million or less.

20. The high voltage connector of claim 1, wherein 72 hours after formation of an aqueous dispersion containing 70 wt. % of a deionized water phase and 30 wt. % of the polyamide composition, the pH value of the deionized water phase is from about 4 to about 8.

21. An electric vehicle comprising a powertrain that includes at least one electric propulsion source and a transmission that is connected to the propulsion source via at least one power electronics module, wherein the electrical vehicle comprises the high voltage connector of claim 1.

22. The electric vehicle of claim 22, wherein the high voltage connector of claim 1 electrically connects the propulsion source to the power electronics module and/or electrically connects the power electronics module to the transmission.

23. The electric vehicle of claim 21, further comprising a charge connector for plugging into a charge port of the vehicle, wherein the charge connector comprises the high voltage connector of claim 1.

24. The electric vehicle of claim 21, wherein at least one electric machine electrically connects the power electronics module to the transmission, wherein the high voltage connector of claim 1 electrically connects the power electronics module to the electric machine and/or the electric machine to the transmission.

25. The electric vehicle of claim 21, wherein the propulsion source includes a battery.
